(19) United States
(12) Patent Application Publication
(10) Pub. No.: US 2021/0162629 A1
(43) Pub. Date: Jun. 3, 2021

(54) MONITORING DEVICE OF A MIXER TRUCK INCLUDING AN AGITATING VESSEL

(71) Applicant: CUBE, LEULINGHEN BERNES (FR)

(72) Inventor: Jean-François BATTEL, LEULINGHEN BERNES (FR)

(21) Appl. No.: 17/102,483

(22) Filed: Nov. 24, 2020

(30) Foreign Application Priority Data
Nov. 28, 2019 (FR) 1913371

(51) Int. Cl. B28C 5/42

(52) U.S. Cl. CPC B28C 5/422; B28C 5/4272

(57) ABSTRACT

A device for monitoring the delivery of the loading of a mixer truck including an agitating vessel is disclosed. The monitoring device comprising a housing with at least one gyroscope and/or at least one accelerometer mounted in the housing and supplying data, and means for fastening the housing on the mixer truck, wherein said fastening means are configured to removably fasten the housing on the agitating vessel of the mixer truck.

### TECHNICAL FIELD

The present disclosure relates to the field of mixer trucks including an agitating vessel, and in particular the field of monitoring the delivery of the content of the agitating vessel.

### BACKGROUND

Mixer trucks are used to deliver, at a delivery or unloading site, concrete supplied by a production or loading site. Mixer trucks include for this purpose an agitating vessel, or drum, into which the concrete is poured at the loading site. The agitating vessel is driven in rotation over the entire routing path until the unloading site to prevent its setting. Once the mixer truck has arrived at the unloading site, the direction of rotation of the agitating vessel is reversed and the concrete contained in the agitating vessel is unloaded at the desired location.

It is known to use concrete delivery monitoring systems, with data entry and communication means, mounted on the mixer truck. In particular, current monitoring systems are connected to the mixer truck, generally at the means for driving in rotation the agitator vessel, and are configured by the driver of the mixer truck during the different steps of the delivery.

However, the operation of systems of this type is constraining, particularly for mixer truck drivers for whom the use of such devices is not intuitive and which can differ from one monitoring system to another. Moreover, the mixer trucks not always being used by the same company, it is also difficult to manage user changes for the same monitoring system connected to a mixer truck. Finally, monitoring systems of this type have also proven to be fragile, and in particular with poor resistance to strong cleaning carried out on mixer trucks.

### SUMMARY

The present disclosure aims to resolve the different previously stated technical problems. The present disclosure also aims to propose a delivery monitoring device of a mixer truck which is easy to operate, the management of which is simplified for the user of a monitoring system, and which has better reliability than current system. In particular, the present disclosure thus aims to propose a delivery monitoring device which improves the effective monitoring of the delivery while limiting the actions to be carried out by the driver of the mixer truck.

Thus, according to one aspect, there is proposed a delivery monitoring device for the loading of a mixer truck including an agitating vessel, the monitoring device comprising a housing with:
at least one gyroscope and/or at least one accelerometer mounted in the housing and supplying data, and
means for fastening the housing on the mixer truck.
   in which said fastening means are configured to removably fasten the housing on the agitating vessel of the mixer truck.

Thus, thanks to the removable housing, it becomes possible to have a monitoring device which is not linked to the mixer truck. The housing according to the present disclosure, and therefore the monitoring device, can then be used only during the phases of concrete delivery, by fastening the housing on the agitating vessel before or after loading the concrete for example, and be stored in the premises of the user of the monitoring device when there are no more deliveries to be monitored. Thus, during the cleaning of the agitating vessel, the housing can be removed from it in order to avoid any risk of breakage or breakdown.

Moreover, the housing according to the present disclosure can be positioned on any mixer truck used by the user of the monitoring device. The changes carried out on a fleet of mixer trucks by adding, replacing or by removal of certain trucks from the fleet do not then modify the management of the monitoring device because the housings are independent of the mixer trucks. The operators of mixer trucks need only retrieve a housing in the premises of the user of the monitoring device, then fasten it on the agitating vessel of the mixer truck to make the monitoring operational, then withdraw it from the mixer truck when the mixer truck is no longer used.

In fact, the housing is independent of the mixer truck. It can thus be freely fastened or withdrawn from the vessel of any mixer truck. The housing is also autonomous. In particular, the housing does not use any resource, energy for example, of the truck, and also does not use data supplied by sensors or portions of the mixer truck: the housing is configured to retrieve information independently of the mixer truck on which it is fastened.

Preferably, the housing comprises an inertial unit including at least three gyroscopes and at least three accelerometers.

The inertial unit allows knowing the movements that the housing carries out. It then becomes possible to record or to communicate to a person the different movements of the housing, and therefore of the agitating vessel of the mixer truck. In particular, different events, expected or not, can thus be detected or communicated by the housing, for example a prolonged stop of the mixer truck or a change in the direction of rotation of the agitating vessel.

Preferably, the fastening means comprise magnets configured to fasten the housing on the agitating vessel of the mixer truck.

The magnets allow reversible fastening of the housing on the agitating vessel, and are easy to use. In particular, the magnets do not require a support on the vessel, but can be fastened to it directly, without an intermediate element. Moreover, the magnets also limit the risk of poor fastening likely to lead to a fall, and therefore to losing the housing.

Preferably, the housing also comprises an activation means configured to be able to indicate when the housing is fastened to an agitating vessel of a mixer truck

The activation means allows knowing, during monitoring by the monitoring device, at what times the housing is fastened to an agitating vessel and at what times it is detached or has fallen from it. An activation means of this type then allows making other information communicated by the housing more reliable. Alternatively, an activation means of this type allows leaving the sensors and the electronics of the housing in standby mode when it is not fastened to an agitating vessel, and thereby saving battery power, and recording or communicating the information from the sensors only when the housing is fastened to the agitating vessel. The operation of the housing by the driver of the mixer truck then becomes particularly easy and intuitive, because it is sufficient to only actuate the activation means of the housing at the time when the delivery begins and when it is desired to monitor it, for the housing to become effectively operational.

Preferably, the activation means is configured to automatically detect when the housing is fastened to an agitating vessel.

In an embodiment of this type, the activation of the housing is not carried out by a person, for example by the driver of the mixer truck, but is carried out automatically when the housing is fastened to an agitating vessel. The use of the housing is thereby further simplified because the driver of the mixer truck need only fasten it to the agitating vessel.

Preferably, the activation means includes a button protruding outside the housing over a length greater than the distance separating the housing from an agitating vessel when the housing is attached to an agitating vessel, so that the fastening of the housing on an agitating vessel causes pressure on the button.

In an embodiment of this type, the activation of the housing is carried out by pressure on a button intended to be located between the body of the housing and the agitating vessel. The shape of the housing, particularly of the body and of the button, is configured so that the button is pressed by the wall of the agitating vessel when the housing is attached to said agitating vessel. Conversely, when the housing is detached from the agitating vessel, this liberates the button and thereby deactivates the operation of the housing, for example to save its battery power.

Preferably, the housing also comprises communication means, preferably wireless and more preferably GSM communication means, receiving as inputs the data supplied by the gyroscope(s) and/or the accelerometer(s).

The communication means allow transmitting the data supplied by the sensors of the housing to a distant person. It then becomes possible to supervise, directly and at a distance, the delivery of the concrete from a mixer truck and, more generally, the deliveries of concrete by several mixer trucks. It becomes possible, in particular, to detect whether the unloading site is free, or on the contrary already blocked by several mixer trucks waiting to unload the concrete contained in their agitating vessel, and therefore to consequently adapt the movement of other mixer trucks toward the unloading site.

Preferably, the housing also comprises a geolocation means and/or a temperature sensor and/or an electrical power supply.

The geolocation means allows knowing, in addition to the data supplied by the sensors of the housing, the position of the mixer truck while obtaining said data. It is then possible to improve the monitoring of deliveries by better understanding the possible anomalies detected by the housing, for example a breakdown of the mixer truck or a prolonged stop imposed by traffic, and by acting in consequence.

Preferably, the fastening means are configured to adapt to the curvature of the surface of the agitating vessel, regardless of the orientation of the housing on the agitating vessel. Preferably, the fastening means are mounted movably on the housing, for example sliding in a direction perpendicular to the surface of the agitating vessel.

The agitating vessels of mixer trucks are generally of cylindrical shape, with a rounded front wall and a lateral wall having several different inclinations relative to the axis of the cylinder. The fastening means are thus configured to adapt to the wall of the agitating vessel on which they are required to be fastened, so as to allow effective fastening and limit the mechanical stresses on the housing. The fastening means can thus be mounted sliding relative to the housing, or more precisely to the body of the housing, in order to allow contact between the fastening means and the wall of the agitating vessel without forcing the housing to deform due to the curvature of the agitating vessel.

Preferably, the monitoring device, and preferably the housing, also comprises a means for processing the data supplied by the gyroscope(s) and/or the accelerometer(s), and configured to identify one or more steps of delivering the loading of the mixer truck, such as loading, arrival on site, and/or unloading of the concrete by the mixer truck, from data supplied by the gyroscope(s) and/or the accelerometer(s), for example from the direction of rotation of the agitating vessel and/or from the movement or the stopping of the mixer truck.

The data processing means can be mounted in the housing. In this case, the data processing means allows retrieving and analyzing directly in situ the data supplied by the sensor(s) of the housing. Thus, instead of transmitting the set of data supplied by the sensors, the housing may transmit only the processed data or the pertinent data, for example the state of progress of the main steps in a delivery, particularly in order to limit the energy consumption of the batteries of the housing.

Alternatively, the data processing means can be distant from the housing, may be situated for example in a server which can communicate with the housing. In this case, the different data obtained by the sensors of the housing are transmitted to a supervision means comprising the distant data processing means, and the analysis of these data is not carried out in situ, by the housing itself, but by the distance supervision means, according for example to the information desired by the user at a given time. In this case, the housing is required to transmit more information, consumes no energy for processing the data.

### BRIEF DESCRIPTION OF THE DRAWINGS

FIG. 1 shows a conventional mixer truck with an agitating vessel for delivering concrete.

FIG. 2 shows schematically a monitoring device with a housing according to the present disclosure, and

FIG. 3 is a photo of a housing of a monitoring device according to the present disclosure, seen from the side intended to be fastened to a surface of an agitating vessel.

### DESCRIPTION OF THE EMBODIMENTS

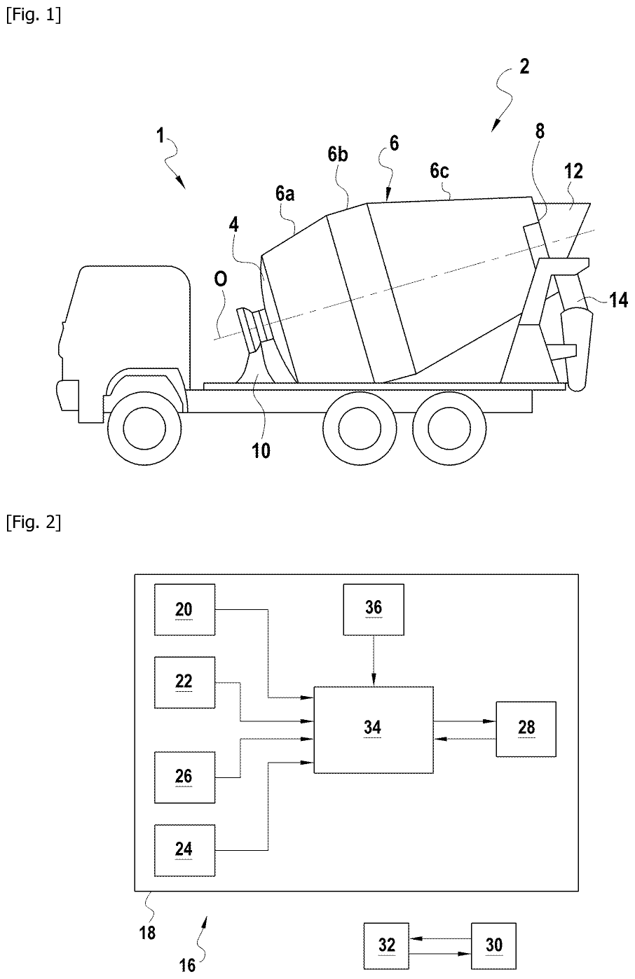

FIG. 1 shows a mixer truck 1 for the delivery of concrete in particular. The mixer truck 1 thus comprises an agitating vessel 2 mounted in rotation around its axis O. The agitating vessel 2 has a generally cylindrical shape, with a front end 4, or head, a lateral face 6 and a rear face 8.

In FIG. 1, the lateral face 6 of the agitating vessel 2 includes three adjacent sections 6a, 6b and 6c. The first portion 6a, situated at the front of the agitating vessel 2, has the shape of a truncated cone oriented forward. The portion 6c, situated at the rear of the agitating vessel 2, has the shape of a truncated cone oriented rearward. The portion 6b, situated between the portions 6a and 6c, has a cylindrical shape.

The front side 4 of the agitating vessel 2 is closed by a rounded wall, and is mounted on a drive means 10 configured to drive the agitating vessel 2 in rotation. Driving in rotation of the agitating vessel 2 has the purpose of avoiding the setting of the concrete contained in it during routing of the concrete to the unloading site. Moreover, the drive means 10 also allows, when the direction of rotation is reversed, discharging the concrete contained in the agitating vessel 2.

The rear side 8 is open and allows the loading of the concrete into the agitating vessel 2, for example from an access means 12 in the form of a funnel, and the discharge of the concrete contained in the agitating vessel 2, for example from a distribution means 14 mounted in rotation relative to the mixer truck 1.

In order to allow the monitoring of the delivery of the concrete from the loading site to the unloading site, as well as possibly the return of the mixer truck to the loading site, the disclosure proposes a monitoring device 16 intended to allow monitoring at a distance of the delivery of the concrete and shown schematically in FIG. 2.

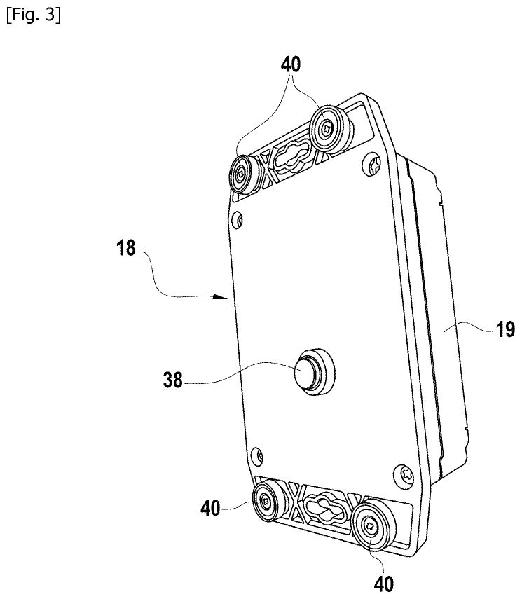

The monitoring device 16 thus comprises a housing 18 intended to be fastened to the agitating vessel 2 of the mixer truck 1, and more particularly to the front face 4 or the lateral face 6 of the agitating vessel 2. The housing 18 is illustrated schematically in FIG. 2, with the functional means that it comprises, and is shown in perspective in FIG. 3. The housing 18 can in particular comprise a container 19, or box, in which are mounted the different means of the housing 18, as well as an electrical power supply (not shown), for example a rechargeable battery, or storage batteries, or batteries.

The housing 18 has as its purpose to collect information on the operation of the mixer truck 1 and of the agitating vessel 2. The housing 18 thus comprises at least one accelerometer 20 and/or at least one gyroscope 22 allowing detecting at least one movement of the mixer truck 1 and/or a rotation of the agitating vessel 2, and supplying the corresponding data. The goal of the sensors is in particular to be able to detect the movement of the mixer truck 1, in order to know whether it is in transit, is blocked on the road or is on a loading or unloading site, while the gyroscope allows knowing whether, and in which direction, the agitating vessel 2 is turning and therefore knowing in particular whether the concrete is in the process of unloading or has been unloaded at the unloading site.

The housing 18 can preferably comprise an inertial unit including at least three accelerometers mounted according to the three dimensions of space, and at least three gyroscopes mounted according to the three dimensions of space. An inertial unit therefore allow detecting all the movements and rotations of the housing 18 in space: an inertial unit thus allows determining the movements and rotations of the housing, regardless of the position in which the housing 18 is fastened to the agitating vessel 2 of the mixer truck 1. With an inertial unit, it is then no longer necessary to provide a mount for the housing 18 on the agitating vessel 2 in a specific direction, particularly to ensure that the measurements carried out by the sensors will be usable.

The housing 18 can also comprise other sensors, so as to supply more detailed information on the routing conditions of the concrete by the mixer truck 1. The housing 18 can thus comprise a geolocation means 24, allowing knowing the position of the mixer truck 1 and therefore confirming the indications also supplied by the accelerometer(s). The geolocation means 24 can allow locating the position of the mixer truck 1 when it is blocked during the routing of the concrete, for example due to automobile traffic or possibly due to a breakdown. It can also allow knowing whether the mixer truck 1 is already on the unloading site but waiting to be able to unload its concrete, particularly because there are already several other mixer trucks in front of it.

Likewise, the housing 18 can comprise a temperature sensor 26 allowing measuring and supplying the temperature in immediate proximity of the agitating vessel 2. A temperature sensor 26 of this type allows in particular knowing the routing conditions of the concrete, and ensuring that the meteorological conditions, temperature in particular, are compatible with the use of the concrete contained in the agitating vessel.

The housing 18 also comprises communication means 28 configured to transmit the data that it receives to communication means 30, to a server for example. The communication means 28 can in particular be virtual data transmission means. In this case it can be wireless transmission via the mobile telephone networks for example, and more precisely via the LTE-M protocol in particular which uses the 4G mobile telephone network, or via other wireless communication protocols such as WiFi or Bluetooth transmissions. In this case, the communication means 30 can be distant from the communication means 28. The communication means 28 can then allow real-time communication of the data collected by the sensors of the housing 18 to a distant server, which allows supervising at a distance the state of the concrete delivery.

Alternatively, the communication means 28 can be wired transmission means, for example via a USB cable or connection. In this case, the data supplied by the housing 18 can be used to ensure, a posteriori, the proper progress of the delivery and/or to know and save the delivery conditions of the concrete.

In both cases, the data supplied by the housing to the communication means 30 are then transmitted by the communication means 30 to a supervision means 32. The supervision means 32 can be configured to only display the data received from the housing 18, or on the contrary be configured to display the data and send requests to the housing 18 via the communications means 30, 28 so as to establish an interaction between the supervision means 32 and the housing 18. For example, the supervision means 32 can be configured to send requests to the housing 18, but also to configure, therefore at a distance, the adjustments of the housing 18, such as in particular the detection thresholds, or sensitivity of the housing 18.

The supervision means 32 can also be configured to process the data received, for example to process the raw data supplied by the sensors of the housing 18 and transmitted by the communication means 28, or to operate a second processing level on the, possibly already processed, data supplied by the housing 18.

The supervision means 32 can finally be configured to also, or solely, record and save the information collected by the housing 18.

In the case illustrated in FIG. 2, the monitoring device 16 only comprises a single housing 18. Nevertheless, it is understood that the monitoring device 16 can, or is intended to, comprise several housings 18 used in parallel on several mixer trucks 1. The supervision means 32 is in this case configured to allow the monitoring and the management of different housings 18, at the same time, by using the data transmitted by each of the housings 18. It then becomes easy to supervise, but also to adapt, the deliveries of the different mixer trucks 1 depending on the data collected directly by the housings 18 from the moving mixer trucks 1.

By way of an example, the supervision means 32 can be an application available on a server and installed on a terminal, such as a computer or a smartphone. An application of this kinds has in particular the advantage of being able to be updated, for example so as to enrich the functionalities or even to adapt it to different situations which may be encountered during the use of the monitoring device 16.

In the example illustrated in FIG. 2, the data supplied by the sensors 20, 22, 24 and 26 are not transmitted directly to the communication means 28, but are connected, at their output, to a data processing means 34. The data processing means 34 thus allows retrieving the different data supplied by the accelerometer(s) 20, the gyroscope(s) 22, the geolocation means 24 and the temperature sensor 26, and to process them to deduce from them usable processed information smaller in size. The data processing means 34 can in particular be configured to identify one or more steps of delivering concrete, such as loading, arrival on site and/or unloading of the concrete, from data supplied by the different sensors of the housing 18. For example, a change in the direction of rotation of the agitating vessel 2 can be analyzed by the data processing means 34, such as unloading of the concrete contained in the agitating vessel 2 on the unloading site. The information processed by the data processing method 34 can then be transmitted to the communication means 28 for transmission to the supervision means 32.

The data processing means 34 can also be configured to exchange with the supervision means 32, via the communication means 28 30. Thus, the data processing means can be configured to be able to process and respond to requests of the supervision means 32. The supervision means 32 can also be configured to be able to update, particularly at a distance, the data processing means 34, i.e. replace the internal software (or firmware) of the data processing means 34. It thus becomes possible to update, and therefore to evolve, the housing(s) 18 without necessitating previously retrieving them physically.

The data processing means 34 thus allows a reduction in the quantity of information transmitted by the transmission means 28, and thus limiting its consumption of electrical energy, even if the data processing means 34 also consumes electrical energy.

The housing 18 can also comprise an activation means 36. The activation means 36 is a means configured to detect, preferably automatically, when the housing 18 is fastened to an agitating vessel 2 of a mixer truck 1. The activation means 36 can thus be configured to trigger the operation of the housing 18 when it is fastened to the agitating vessel 2 of a mixer truck 1. The activation means 36 can in particular trigger measurements by the different sensors of the housing 18, and possibly process of the data by the processing means 34 or even the transmission/reception of data by the communication means 28.

The activation means 36 has as its goal in particular to activate the functionalities of the housing 18, preferably automatically, when it is positioned on the agitating vessel 2 of a mixer truck 1.

Alternatively or in addition, the activation means 36 can also be configured to be able to indicate when the housing is fastened to the agitating vessel 2 of a mixer truck.

To this end, the activation means 36 can comprise a button 38 mounted on the housing 18, and more particularly on the container 19, on the side intended to be fastened to a surface of the vessel. The button 38 protrudes outside the housing 18, and more particularly outside the container 19, and over a length greater than the distance separating the housing 18 from the agitating vessel 2, when the housing is fastened to the agitating vessel 2. Thus, when the housing 18 is fastened to an agitating vessel 2, the button 38 is automatically pressed by the wall of the vessel to which the housing 18 is fastened: this allows automatically detecting, without requiring any specific action on the part of the person placing the housing on the vessel, that the housing 18 is mounted on a vessel and that the different sensors of the housing 18 can be made active.

The type of the button 38, and more generally of the activation means 36, can be directly linked to the mode of fastening the housing 18 on the agitating vessel 2. The fastening means of the housing 18 are in particular configured to bring the housing 18 closer to the agitating vessel 2 by a distance less than the size of the button 38.

According to the present disclosure, the housing 18 comprise removable fastening means, i.e. fastening means configured to fasten the housing 18, and more precisely the container 19, on the agitating vessel 2 of a mixer truck 1, in a reversible manner. For example, and as illustrated in FIG. 3, the housing 18 comprises fastening means 40 comprising magnets, four for example, mounted at the four corners of the container 19 which has, in the case illustrated in FIG. 3, a parallelepiped shape overall. The container 19 can in particular be in two parts with a shell and a support screwed together, the support being intendeds to be fastened, via the fastening means 40, on the agitating vessel 2.

The fastening means 40 are configured to prevent the housing 18 from falling from the agitating vessel 2 during use. Thus, an in order to limit the stresses between the agitating vessel 2 and the housing 18 when it is mounted on the agitating vessel 2, the fastening means 40 are configured to adapt to the shape of the agitating vessel 2, in in particular to the curvature of the agitating vessel 2. For example, the fastening means 40 can comprise one or more magnets movably mounted on the container 19 support. Each magnet can in particular be mounted on the support by a slide link, on the end of a rod passing through the support and connected by a spring for example. In this case, the spring allows the housing 18 to be pressed against the wall of the agitating vessel 2, in order to ensure the activation of the button 38, while allowing clearance between the housing 18 and the agitating vessel 2 to compensate the geometric bulk which can appear between the housing 18 and the agitating vessel 2.

Thus, thanks to the housing according to the present disclosure, it becomes possible to have monitoring of one or more mixer trucks which are intended to deliver concrete. The housing according to the present disclosure can be easily installed on and removed from the vessel, to easily carry out the monitoring only on the desired mixer trucks. Moreover, thanks to its removable aspect and to its functionalities, it also becomes easier to renew, replace but also improve the monitoring functionalities of the monitoring device, particularly to adapt it to the changes in the mixer truck fleet and to delivery constraints.

1. A device for monitoring the delivery of the loading of a mixer truck including an agitating vessel, the monitoring device comprising:
a housing;
at least one gyroscope and/or at least one accelerometer mounted in the housing and supplying data; and
means for fastening the housing on the mixer truck,
wherein said fastening means is configured to removably fasten the housing on the agitating vessel of the mixer truck.

2. The device according to claim 1, wherein the housing comprises an inertial unit including at least three gyroscopes and at least three accelerometers.

3. The device according to claim 1, wherein the fastening means comprises magnets configured to fasten the housing on the agitating vessel of the mixer truck.

4. The device according to claim 1, wherein the housing also comprises an activation means configured to be able to indicate when the housing is fastened to an agitating vessel of a mixer truck.

5. The device according to claim 4, wherein the activation means is configured to automatically detect when the housing is fastened to an agitating vessel.

6. The device according to claim 4, wherein the activation means includes a button protruding outside the housing over a length greater than the distance separating the housing from an agitating vessel when the housing is fastened to an agitating vessel, so that the fastening of the housing on an agitating vessel causes pressure on the button.

7. The device according to claim 1, wherein the housing also comprises communication means for receiving as inputs the data supplied by the gyroscope(s) and/or the accelerometer(s).

8. The device according to claim 1, wherein the housing also comprises a geolocation means and/or a temperature sensor and/or an electrical power supply.

9. The device according to claim 1, wherein the fastening means is configured to adapt to the curvature of the surface of the agitating vessel, regardless of the orientation of the housing on the agitating vessel.

10. The device according to claim 1, further comprising a means for processing the data supplied by the gyroscope(s) and/or the accelerometer(s), and configured to identify one or more steps of delivering the loading of the mixer truck from data supplied by the gyroscope(s) and/or the accelerometer(s).

11. The device according to claim 10, wherein the one or more steps of delivering the loading of the mixer truck comprises one or more of loading, arrival on site, and unloading of the concrete by the mixer truck.

12. The device according to claim 10, wherein the data supplied by the gyroscope(s) and/or the accelerometer(s) comprise the direction of rotation of the agitating vessel and/or the movement or the stopping of the mixer truck.

13. The device according to claim 7, wherein the communication means comprises wireless communication means.

14. The device according to the claim 13, wherein the wireless communication means comprises GSM communication means.

15. The device according to claim 9, wherein the fastening means is mounted movably on the housing.

16. The device according to claim 15, wherein the fastening means is mounted sliding in a direction perpendicular to the surface of the agitating vessel.
